(19) United States
(12) Patent Application Publication
(10) Pub. No.: US 2013/0159653 A1
(43) Pub. Date: Jun. 20, 2013

(54) Predictive Lock Elision

(71) Applicants: Martin T. Pohlack, Dresden (DE); Stephan Diestelhorst, Dresden (DE)

(72) Inventors: Martin T. Pohlack, Dresden (DE); Stephan Diestelhorst, Dresden (DE)

(21) Appl. No.: 13/331,221

(22) Filed: Dec. 20, 2011

(51) Int. Cl. G06F 12/14

(52) U.S. Cl. 711/163; 711/E12.094

(57) ABSTRACT

In at least one embodiment, a method includes determining whether to elide a lock operation based on success of or failure of one or more previous transactional memory operations associated with one or more respective previous lock elisions. In at least one embodiment of the method, the lock operation is associated with a first access of a shared resource and the one or more previous lock elisions are associated with respective one or more previous accesses of the shared resource.

### BACKGROUND

1. Field of the Invention

This disclosure relates to computing systems and more particularly to transactional memory operations in computing systems.

2. Description of the Related Art

Recent developments in computing have exploited parallelism, enabling faster computational processes. For example, a processor may include multiple processing cores that each executes instructions in parallel. However, the cores can at times “compete” for control of resources (e.g., a shared memory). Accordingly, programmers can use synchronization mechanisms to coordinate access to shared resources. However, the synchronization mechanisms often operate by serializing access to resources, reducing the level of parallelism.

### SUMMARY OF EMBODIMENTS OF THE INVENTION

In at least one embodiment, a method includes determining whether to elide a lock operation based on success of or failure of one or more previous transactional memory operations associated with one or more respective previous lock elisions. In at least one embodiment of the method, the lock operation is associated with a first access of a shared resource and the one or more previous lock elisions are associated with respective one or more previous accesses of the shared resource.

In at least one embodiment, an apparatus includes a plurality of processing cores. The plurality of processing cores includes at least a first processing core configured to determine whether to elide a lock operation based on success of or failure of one or more previous transactional memory operations associated with one or more respective previous lock elisions. In at least one embodiment of the apparatus, the first processing core includes transactional memory logic configured to determine success or failure of transactional memory operations.

In at least one embodiment, a non-transitory computer-readable medium encodes instructions to cause a processor to determine whether to elide a lock operation based on success of or failure of one or more previous transactional memory operations associated with one or more respective previous lock elisions. In at least one embodiment of the non-transitory computer-readable medium, the instructions are encoded in a shared library.

### BRIEF DESCRIPTION OF THE DRAWINGS

The present invention may be better understood, and its numerous objects, features, and advantages made apparent to those skilled in the art by referencing the accompanying drawings.

FIG. 1 depicts a block diagram of an illustrative embodiment of a system according to at least one embodiment of the invention.

FIG. 2 depicts a block diagram of an illustrative embodiment of a library according to at least one embodiment of the invention.

FIG. 3 depicts a state diagram illustrating an example operation of a state machine according to at least one embodiment of the invention.

FIG. 4 depicts pseudocode that illustrates exemplary instructions for intercepting an exemplary lock call according to at least one embodiment of the invention.

FIG. 5 depicts a flow diagram illustrating a particular exemplary operation of the system of FIG. 1.

The use of the same reference symbols in different drawings indicates similar or identical items.

### DETAILED DESCRIPTION

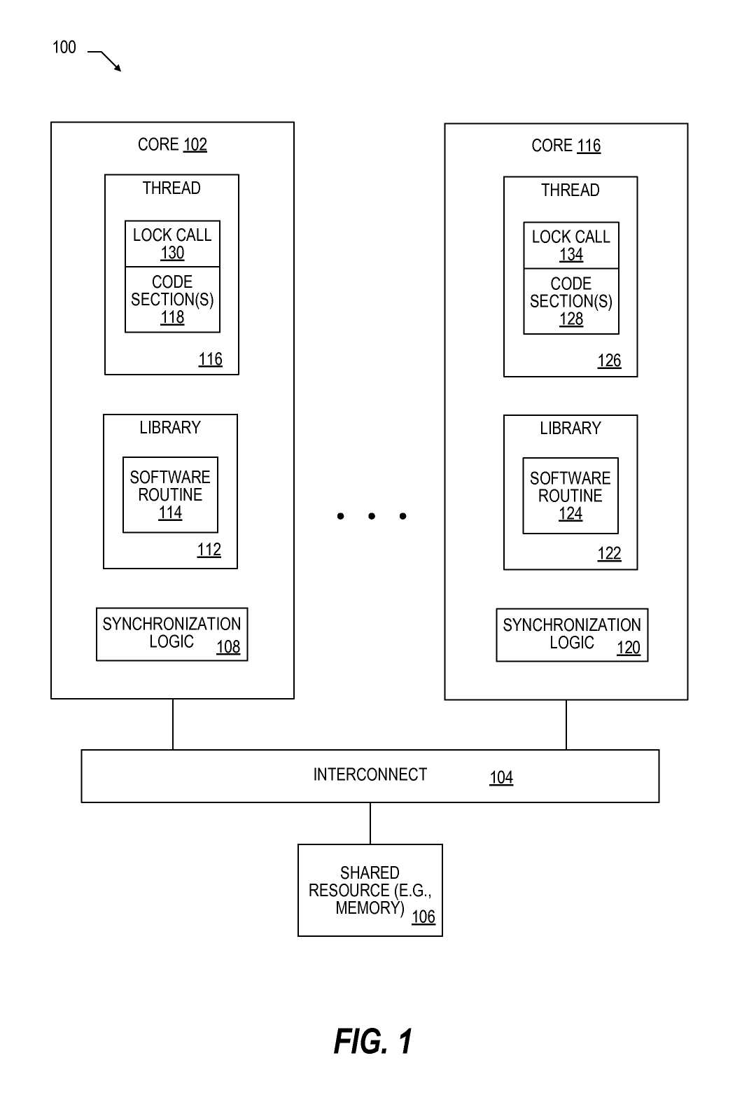

FIG. 1 is a block diagram of an illustrative embodiment of system 100, which includes multiple cores, such as core 102 and core 116. Cores 102 and 116 are coupled to a shared resource 106 (e.g., a memory) via interconnect 104 (e.g., a crossbar or other suitable bus structure). Although the particular embodiment of system 100 in FIG. 1 includes two cores, it should be appreciated that exemplary systems can include any number of cores.

Cores 102 and 116 may execute instructions, such as instructions of threads 116 and 126, respectively. Execution of such instructions may generally occur in parallel between cores 102 and 116. However, if a thread contains one or more code sections (e.g., code section 118 or 128) that access a shared resource (such as shared resource 106), such code sections may be executed in conjunction with a lock call (e.g., lock calls 130 and 134, respectively). An example of such a code section is a “critical section” that modifies a memory location at shared resource 106. Other such critical sections used in connection with lock calls are known in the art.

To further illustrate, if thread 116 is to execute code section 118 that accesses shared resource 106, thread 116 can acquire a lock to shared resource 106 using lock call 130 (temporarily excluding thread 126 from accessing shared resource 106), execute code section 118, and then release the lock once execution of code section 118 has completed (e.g., using a suitable unlock call). Such lock operations generally reduce or eliminate the possibility of inter-thread conflicts associated with concurrent accesses of shared resources at the expense of serializing access to shared resources.

However, not all concurrent accesses to a shared resource necessarily conflict. For example, a conditional store instruction that does not successfully execute may not cause an actual conflict. As another example, accessing different fields of a shared resource may not cause an actual conflict. Accordingly, performing each lock operation can waste cycles by serializing access to shared resources when parallel access would not cause an actual conflict to occur.

Accordingly, cores 102 and 116 may execute instructions contained in libraries 112 and 122 (which can be loaded from an external source, such as shared resource 106). Libraries 112 and 122 may be a shared library that is dynamically linked at runtime. In at least one embodiment, libraries 112 and 122 include software routines 114 and 124 (i.e., processor-usable instructions stored on a tangible computer readable medium), respectively, which include instructions executable by a processor to intercept lock calls (e.g., lock calls 130 and 134) and to determine whether to elide the lock calls. As used herein, “eliding” a lock call and “elision” of a lock call refer to attempting one or more transactional memory operations (e.g., a load/store operation that succeeds or fails as a single atomic operation) in response to detecting the lock call. In at least one embodiment, a determination whether to elide the lock call is based on success of or failure of one or more previous transactional memory operations associated with respective one or more previous lock elisions corresponding to accesses of shared resource 106.

As will be appreciated, if such predictions are made too “aggressively,” performance of system 100 can be degraded by having to roll back the transactional memory operations (e.g., where a conflict is not predicted but occurs), wasting cycles due to aborts and retries. If such predictions are made too “conservatively,” then unnecessary lock operations may be performed (e.g., where a conflict is predicted but would not have occurred), bottlenecking resources and reducing system performance. Accordingly, in at least one embodiment and as described further below, software routines 114 and 124 are “adaptive” software routines that can cause elision to occur more often or less often based on success or failure of one or more previous lock elisions, predicted success of a prospective lock elision, or a combination thereof.

Cores 102 and 116 include synchronization logic 108 and 120, respectively, which may include transactional memory hardware. For example, in at least one embodiment, synchronization logic 108 and 120 include a set of hardware primitives that enable atomic operations on memory locations (e.g., a memory location at shared resource 106). One of skill in the art can use such primitives to build higher-level synchronization mechanisms. Some transactional memory apparatuses and methods are described in U.S. Patent Publication No. 2011/0208921, entitled “Inverted Default Semantics for In-Speculative-Region Memory Accesses,” naming as inventors Martin T. Pohlack, Michael P. Hohmuth, Stephan Diestelhorst, David S. Christie, and Jaewoong Chung, which is incorporated by reference herein in its entirety.

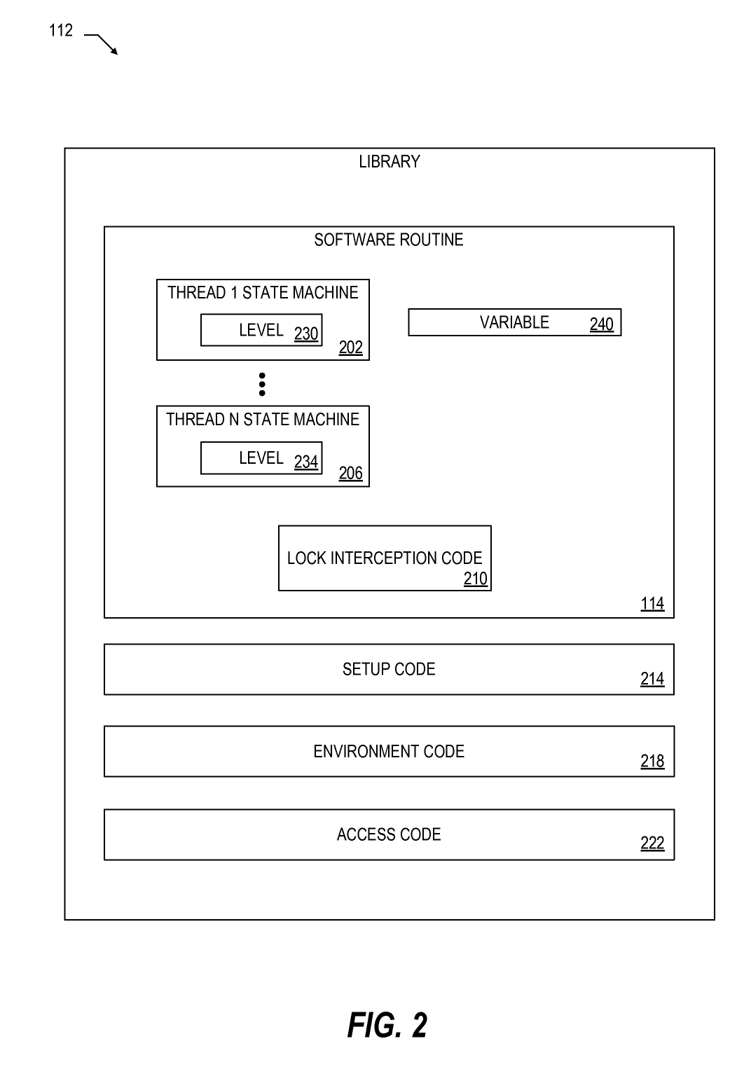

FIG. 2 is a block diagram of an illustrative embodiment of library 112 of FIG. 1. In at least one embodiment, library 112 is encoded on a non-transitory computer-readable medium. As depicted in FIG. 2, library 112 includes software routine 114, which may include instructions corresponding to one or more state machines (e.g., a software counter), such as state machines 202 and 206. State machines 202 and 206 may correspond to respective threads (e.g., may be “thread-specific”). For example, for purposes of illustration herein, state machine 202 of FIG. 2 corresponds to thread 116 of FIG. 1.

State machines 202 and 206 may indicate respective levels (e.g., levels 230 and 234), which may correspond to respective states of state machines 202 and 206. In addition, and as explained further below, software routine 114 may include instructions for maintaining one or more variables each associated with a state machine. For example, in the embodiment of FIG. 2, software routine 114 includes instructions 218 for maintaining variable 240, which corresponds to state machine 202, as described further below. Software routine 114 may further include instructions 210 for intercepting lock calls and for maintaining levels of state machines 202 and 206, as described further below.

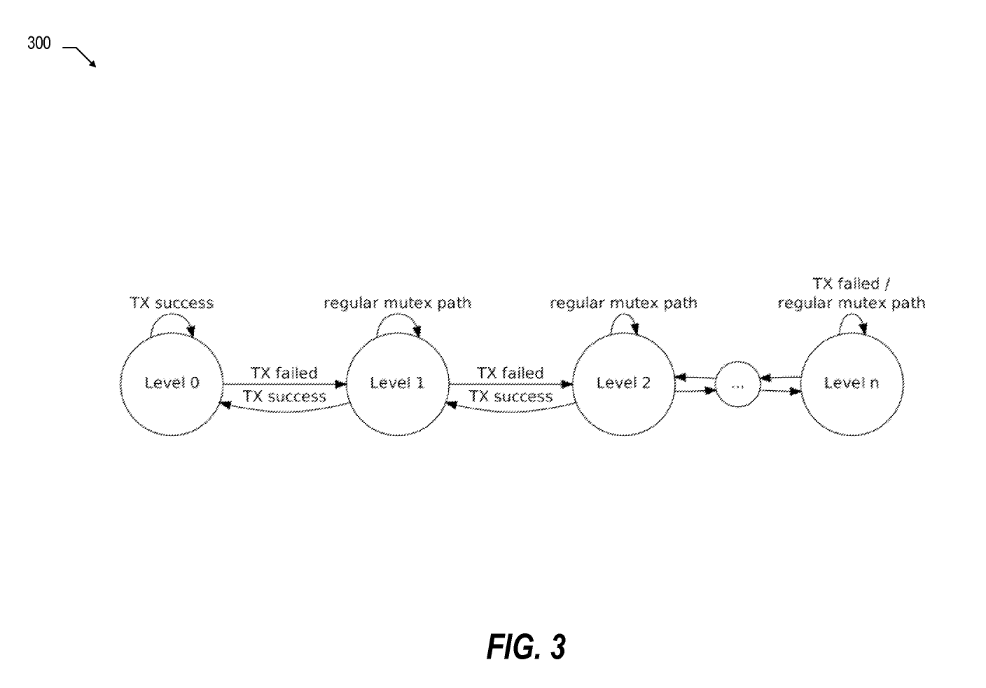

Referring to FIG. 3, state diagram 300 illustrates an example operation of state machine 202 of FIG. 2. State diagram 300 includes multiple levels (e.g., levels 0, 1, 2, . . . n), each corresponding to a different value of level 230. In general, n can be any integer and can be selected depending on the application at hand (e.g., a higher level n for more dynamic environments, etc.). In at least one embodiment, each of the multiple levels indicates a likelihood of success of a transactional memory operation associated with a lock elision by a thread (e.g., thread 116). The likelihood of success can vary exponentially with the level of state diagram 300. For example, in at least one embodiment, the corresponding likelihood of success for each level k is given by ½^{k} (i.e., likelihoods of approximately 100%, 50%, and 25% for k=0, 1, and 2, respectively).

As shown in FIG. 3, levels of state diagram 300 may be based on successes and failures of transactional memory operations. To illustrate, and referring back to the example described with reference to FIG. 2, suppose that at the time thread 116 reaches code section 118, level 230 of state machine 202 corresponds to level 1 of state diagram 300. Suppose also that, in response to code section 118, software routine 114 is called and determines to elide lock call 130 and to attempt to execute code section 118 using a transactional memory operation. If the transactional memory operation is attempted and succeeds, then level 230 of state machine 202 is changed to correspond to level 0 (i.e., state diagram 300 follows the “TX success” path). If the transactional memory operation is attempted and initially fails, the transactional memory operation can either be retried or aborted.

In at least one embodiment, in response to initial failure of the transactional memory operation, one or more retries are performed prior to aborting. The number of retries may correspond to the level of state diagram 300 (e.g., a higher level may correspond to fewer retries, since the likelihood of success may be lower). If after the retries (if any) the transactional memory operation is determined (e.g., by synchronization logic 108 of FIG. 1) to have failed, then software routine 114 “falls back” to the lock operation indicated by lock call 130, and level 230 of state machine 202 is changed to correspond to level 2 (i.e., state diagram 300 follows the “TX failed” path). The number of retries may be indicated by a variable defined by environment code 218 of FIG. 2 (which may further include instructions for modifying behavior of library 112 as appropriate). Because lock call 130 serializes access to the locked resource, falling back to lock call 130 generally ensures that execution of code section 118 will not cause an inter-thread conflict. Further, by attempting at least one a transactional memory operation associated with elision of lock call 130, unnecessary restriction of a resource can be avoided.

Traversal of other levels of state diagram 300 may operate similarly, with successes at level 0 and failures at level n (i.e., “TX success” and “TX failed” paths, respectively) causing no change in level. After execution of the code section, thread 116 can continue operation (e.g., execution of instructions).

In at least the embodiment of state diagram 300 depicted in FIG. 3, performing a lock call without eliding results in no change of level (i.e., state diagram 300 follows the “regular mutex path” for levels 1, 2, . . . n and “TX success” for level 0). For example, continuing in the above example, if software routine 114 determines not to elide lock call 130, then the lock operation indicated by lock call 130 will be performed and level 230 of state machine 202 will remain corresponding to level 1 of state diagram 300. While the appropriate resource is locked, code section 118 executes, after which the resource is unlocked.

In at least one embodiment, state diagram 300 illustrates “adaptive” operation of state machine 202 by indicating a percentage of times that lock calls are elided (e.g., a frequency of lock elisions relative to lock operations performed). For example, for each level k, the corresponding percentage of lock elisions may be given by ½^{k} (i.e., lock elisions made approximately 100%, 50%, and 25% of the time for levels 0, 1, and 2, respectively). Eliding a lock call, even when state diagram 300 indicates that a transactional memory operation is likely to fail, can ensure that state machine 202 “adapts” to current conditions. To illustrate, suppose level 230 of state machine 202 corresponds to level 2 of state diagram 300, which may in turn indicate that a transactional memory operation attempt is likely to fail. The transactional memory operation may still be attempted for a certain percentage of lock calls (e.g., 1 of 4, or 25% of the time) such that if current conditions have changed to make elision more favorable (e.g., thread 126 is idle), then elisions can be performed and level 230 of state machine 202 will “adaptively” change even though level 230 indicates that elision is not currently likely to succeed. Further, by eliding even when level 230 of state machine 202 indicates a low or zero percent chance to elide (or a low or zero percent likelihood of success), level 230 of state machine 202 will not unnecessarily remain “stuck.”

In at least one embodiment, a variable is defined (e.g., using setup code 214 of FIG. 2) that indicates a “count” of performed lock calls at each level. Continuing with the above example, suppose level 230 of state machine 202 at a particular time corresponds to level 2 of state diagram 300. When variable 240 reaches a predetermined number corresponding to the percentage chance to elide associated with level 2, a next lock call may be elided. For example, if level 2 corresponds to a 25% chance to elide, variable 240 may be initialized to 0, and then incremented to 1, 2, and 3 for respective first, second, and third lock operations performed. When variable 240 has a value of 3 (i.e., the predetermined number for level 2 in this example), a next lock call would be elided, then causing variable 240 to be reset to 0, and so forth. In at least one embodiment, for each level k of state diagram 300, the predetermined number is given by (2^{k})−1. In at least one embodiment, instead of maintaining such variables, a random or pseudorandom process can be implemented that achieves the percentage of elisions per lock operations.

Because a lower level of state diagram 300 generally corresponds to increased potential for parallel execution of code sections and therefore enhanced performance, approaches for reducing level 230 of state machine 202 are contemplated. According to a first approach, a next lock call is elided after a level reduction. For example, suppose a lock call is encountered while level 230 of state machine 202 corresponds to level 2 and the lock call is elided. If the corresponding transactional memory operation is performed successfully, level 230 of state machine 202 is accordingly changed to correspond to level 1. According to the first approach, a transactional memory operation would then be attempted in response to a subsequent lock call, irrespective of the level 230 of state machine 202. According to a second approach, following a successful elision, a number of lock calls are performed prior to eliding another lock call. The number of lock calls may be level specific (e.g., for higher levels, more lock operations may be performed than for lower levels prior to eliding a lock call). As will be appreciated, the first approach may be able to adapt more quickly to environment changes but might be more likely to “overshoot” (e.g., mis-speculate), while the second approach may be “safer” by allowing level 230 of state machine 202 to “settle” prior to eliding subsequent lock calls. In at least one embodiment, access code 222 of FIG. 2 includes instructions for defining behavior of library 112 according to the first or second approach, for modifying behavior of state machines 202 and 206, for initializing level 230 of state machine 202, and the like.

In at least one embodiment, software routine 114 includes state machines to track successes and failures of elisions of each lock call (e.g., each mutex) for each thread. Further, such data may be stored in a hash table indexed by addresses of each mutex (e.g., in a hash table stored in a cache included in core 102). According to a particular illustrative embodiment, setup code 214 of FIG. 2 includes appropriate functions for accessing such hash tables and for storing the data. The stored data may further indicate the number of soft aborts of transactional memory operations (e.g., aborts due to transient conditions, such as inter-thread data contention), hard aborts of transactional memory operations (e.g., aborts due to illegal instructions), the number of successful transactional memory operations, and the number of normal lock operations. Such data can, for example, assist in debugging operations and software modifications in view of hardware constraints, etc.

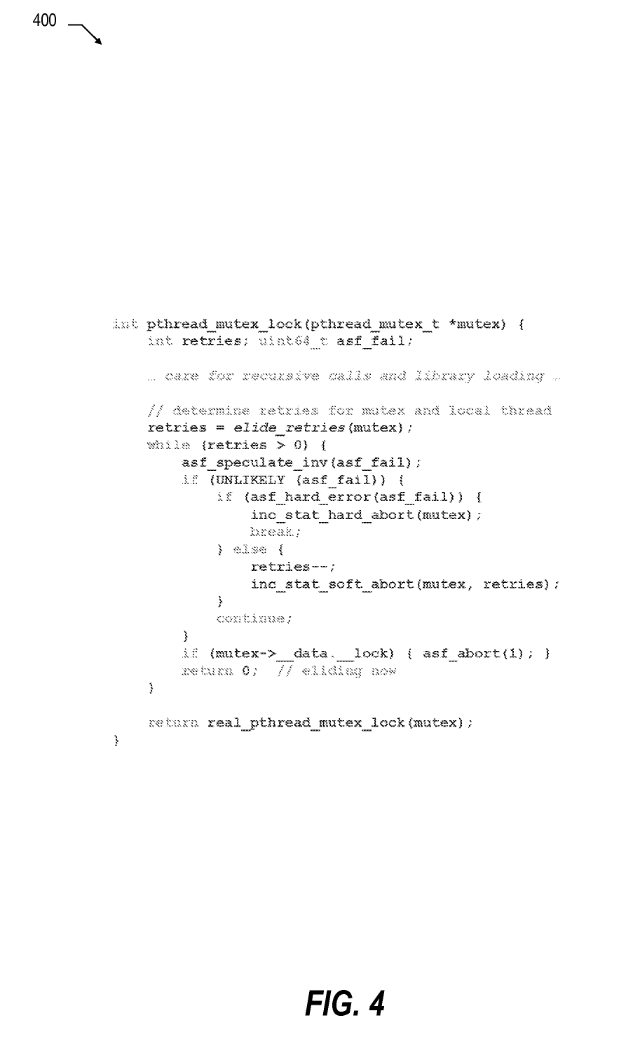

Referring to FIG. 4, pseudocode 400 illustrates exemplary instructions for intercepting an exemplary lock call (i.e., pthread_mutex_lock calls). Such instructions may be included in lock interception code 210 of FIG. 2. In at least one embodiment, library 112 of FIGS. 1 and 2 includes such instructions and can be preloaded to wrap lock calls, such as calls to pthread_mutex_lock and pthread_mutex_unlock. As used herein, “wrapping” a function (e.g., a lock call) refers to intercepting the function and executing a second function to perform operations, e.g., operations described herein. The second function may decline to execute the wrapped function (e.g., may determine to elide a lock call) or may call the wrapped function (e.g., fall back to a lock operation). The second function may execute code before and after executing the wrapped function, as appropriate.

As shown in FIG. 4, in response to a pthread_mutex_lock call, a number retries of times to retry elision of pthread_mutex_lock is determined (e.g., based on a current level of a state machine, such as state machine 202 of FIG. 2, as described with reference to FIG. 3). While iterating the while loop, a transactional memory operation associated with elision of pthread_mutex_lock can be attempted up to retries times, each iteration decrementing retries. However, in case of a hard error, while is exited. Pseudocode 400 depicts that if the transactional memory operation associated with elision of pthread_mutex_lock is successful prior to retries reaching zero, then while is exited. Otherwise, pseudocode 400 “falls back” to calling pthread_mutex_lock.

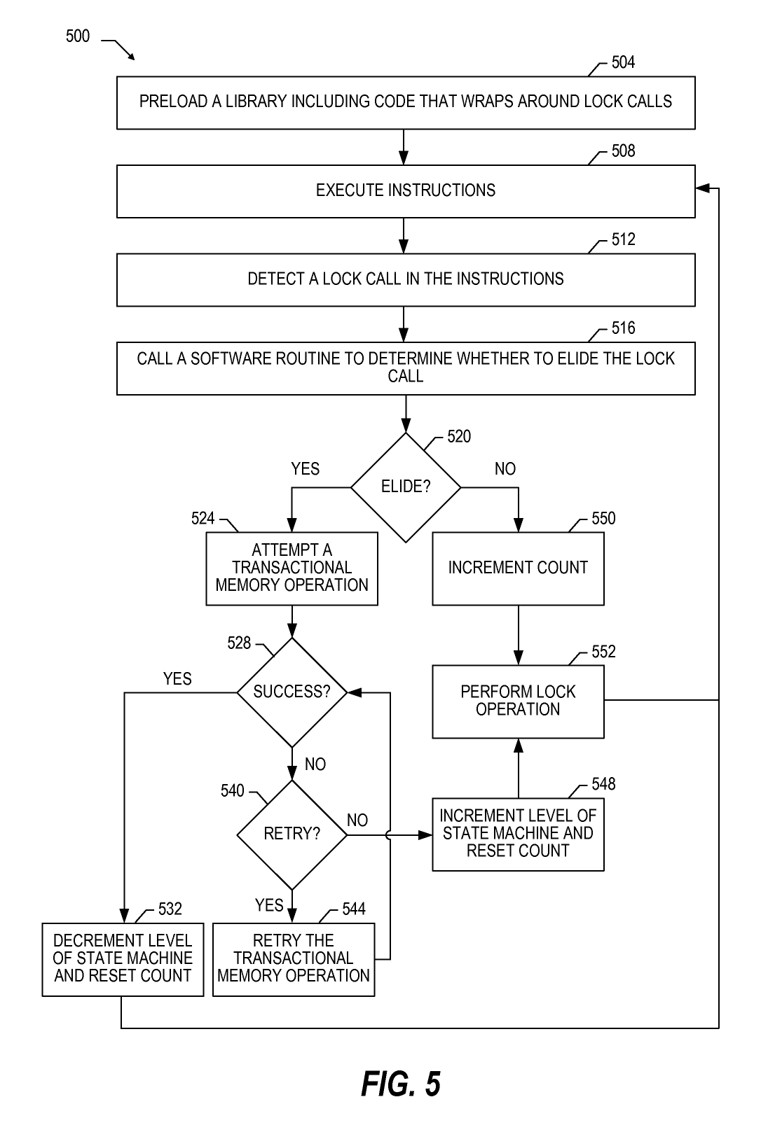

Referring to FIG. 5, flow diagram 500 depicts a particular exemplary operation of system 100 of FIG. 1. Flow diagram 500 includes preloading (e.g., by core 102) a library (e.g., library 112) including code (e.g., lock interception code 210) that wraps around locking operations, at 504, and executing instructions, at 508. At 512, a lock call (e.g., lock call 130) in the instructions is detected, and at 516 a software routine (e.g., software routine 114) is called to determine whether to elide the lock call. Determining whether to elide the lock call may include determining a likelihood of success, a frequency of lock elisions relative to lock operations performed, or a combination thereof.

If at 520 a determination is made to elide the lock call, flow diagram 500 includes attempting a transactional memory operation, at 524. If at 528 the transactional memory operation is successful, a level (e.g., level 230) of a state machine (e.g., state machine 202) is decremented, at 532. A count (e.g., variable 240) may be reset, also at 532, as described with reference to FIG. 3. If at 520 a determination is made not to elide the lock call, flow diagram 500 includes incrementing the count, at 550, and performing the indicated lock operation, at 552.

If at 528 the transactional memory operation is not successful, flow diagram 500 may include determining whether to retry the transactional memory operation, at 540. If no retries are to be made, then flow diagram 500 continues by incrementing the level of the state machine and resetting the count, at 548. Flow diagram 500 then includes performing the lock operation (“falling back” to the lock operation), at 552.

Various structures described herein may be implemented using instructions executing on a processor or by a combination of such instructions and hardware. Instructions may be encoded in at least one tangible (i.e., non-transitory) computer-readable medium that can be read by a processor. As referred to herein, a tangible computer-readable medium includes at least a disk, tape, or other magnetic, optical, or electronic storage medium. In addition, the computer-readable media may store data as well as instructions. In at least one embodiment, a non-transitory computer-readable medium encodes instructions to cause (e.g., instructions executable by) a processor to determine whether to elide a lock operation based on success of or failure of one or more previous transactional memory operations associated with one or more respective previous lock elisions, and to perform other operations described herein with reference to FIGS. 1-5.

Further, various structures described herein may be embodied in computer-readable descriptive form suitable for use in subsequent design, simulation, test or fabrication stages. Various embodiments are contemplated to include circuits, systems of circuits, related methods, and one or more tangible computer-readable media having encodings thereon (e.g., VHSIC Hardware Description Language (VHDL), Verilog, GDSII data, Electronic Design Interchange Format (EDIF), and/or a Gerber file) of such circuits, systems, and methods, all as described herein, and as defined in the appended claims.

The description set forth herein is illustrative, and is not intended to limit the scope set forth in the following claims. For example, structures and functionality presented as discrete components in the exemplary configurations may be implemented as a combined structure or component, and vice versa. As another example, while state machines 202 and 206 of FIG. 2 have been described as being implemented within a software routine of instructions, those of skill in the art will appreciate that state machines 202 and 206 can be implemented in hardware (e.g., hardware counters) or as other state machines that are suitable to indicate a state. Variations and modifications of the embodiments disclosed herein may be made based on the description set forth herein, without departing from the scope and spirit of the invention as set forth in the following claims.

What is claimed is:

1. A method comprising:
determining whether to elide a lock operation based on success of or failure of one or more previous transactional memory operations associated with one or more respective previous lock elisions.

2. The method as recited in claim 1 wherein the lock operation is associated with a first access of a shared resource and wherein the one or more previous lock elisions are associated with respective one or more previous accesses of the shared resource.

3. The method as recited in claim 1 wherein determining whether to elide the lock operation includes determining a likelihood of success of a transactional memory operation, the likelihood of success based on the success of or failure of the one or more previous transactional memory operations.

4. The method as recited in claim 3 further comprising:
determining, based on the likelihood of success, that the transactional memory operation is likely to fail; and
attempting the transactional memory operation.

5. The method as recited in claim 1 further comprising:
eliding the lock operation; and
in response to eliding the lock operation, altering a level of a first state machine,
wherein the level of the first state machine indicates a frequency of lock elision attempts relative to lock operations performed.

6. The method as recited in claim 5 wherein the frequency varies exponentially with the level of the first state machine.

7. The method as recited in claim 5 further comprising, after eliding the lock operation and irrespective of the level of the first state machine, eliding a next lock operation.

8. The method as recited in claim 5 further comprising, after eliding the lock operation, performing a predetermined number of subsequent lock operations prior to eliding a subsequent lock operation.

9. The method as recited in claim 5 wherein the first state machine is associated with a first thread of a multithreaded execution, the method further comprising maintaining a second state machine associated with a second thread of the multithreaded execution.

10. The method as recited in claim 9 wherein the first state machine and the second state machine are associated with a resource that is shared by the first thread and the second thread, the method further comprising tracking successes and failures, by the first state machine and the second state machine, of attempted transactional memory operations associated with accesses to the resource.

11. An apparatus comprising:
a plurality of processing cores comprising at least a first processing core configured to determine whether to elide a lock operation based on success of or failure of one or more previous transactional memory operations associated with one or more respective previous lock elisions.

12. The apparatus as recited in claim 11 wherein the first processing core includes transactional memory logic configured to determine success or failure of transactional memory operations.

13. The apparatus as recited in claim 11 wherein the first processing core is further configured to determine whether to elide the lock operation using instructions executing on the first processing core.

14. The apparatus as recited in claim 11 wherein the first processing core is further configured to alter a level of a state machine in response to success or failure of a transactional memory operation associated with eliding the lock operation.

15. The apparatus as recited in claim 14 wherein the level of the state machine indicates a likelihood of success of eliding the lock operation.

16. The apparatus as recited in claim 15 wherein the likelihood of success varies exponentially with the level of the state machine.

17. A non-transitory computer-readable medium encoding instructions to cause a processor to determine whether to elide a lock operation based on success of or failure of one or more previous transactional memory operations associated with one or more respective previous lock elisions.

18. The non-transitory computer-readable medium as recited in claim 17 wherein the instructions are encoded in a shared library.

19. The non-transitory computer-readable medium as recited in claim 17 wherein the instructions further cause the processor to maintain a state machine having a level that indicates a likelihood of success of a transactional memory operation associated with eliding the lock operation.

20. The non-transitory computer-readable medium as recited in claim 19 wherein the likelihood of success varies exponentially with successes and failures of transactional memory operations.

21. The non-transitory computer-readable medium as recited in claim 17 wherein the instructions further cause the processor to maintain a variable that indicates a frequency of lock elision attempts relative to lock operations performed.
